(19) United States
(12) Patent Application Publication
(10) Pub. No.: US 2025/0127338 A1
(43) Pub. Date: Apr. 24, 2025

(54) APPARATUS FOR AUTOMATICALLY MIXING RAW MATERIAL AND SEASONING

(71) Applicant: JK GLOBAL CO.,LTD., Siheung-si (KR)

(72) Inventor: Jung Geun PARK, Bucheon-si (KR)

(21) Appl. No.: 18/920,834

(22) Filed: Oct. 18, 2024

(30) Foreign Application Priority Data
Oct. 19, 2023 (KR) 10-2023-0140158

(51) Int. Cl. A47J 47/01; A47J 43/04; A47J 47/04; B05B 1/24

(52) U.S. Cl. CPC A47J 47/01; A47J 43/04; A47J 47/04; B05B 1/24

(57) ABSTRACT

The present inventive concept relates to a nozzle-type apparatus for automatically mixing a raw material and a seasoning according to a degree of viscosity of the seasoning, more specifically to an apparatus for automatically feeding a seasoning and mixing the seasoning and a raw material. The apparatus includes: a plurality of mixing containers in each of which the raw material is put; a seasoning discharger located on top of one side of each mixing container and adapted to adjust a temperature of the seasoning to spray the seasoning into the corresponding mixing container; a plurality of agitators located inside each mixing container to mix the seasoning and the raw material; and a controller for selectively controlling the operations of the seasoning discharger and the plurality of agitators.

### TECHNICAL FIELD

The present inventive concept relates to a nozzle-type apparatus for automatically mixing a raw material and a seasoning according to a degree of viscosity of the seasoning, more specifically to an apparatus for automatically feeding a seasoning and mixing the seasoning and a raw material.

### BACKGROUND ART

As food delivery platforms and single-person households have increased, recently, food delivery markets are expanded, and therefore, a variety of foods that satisfy consumer tastes are introduced in the market.

For example, one of the variety of foods is a chicken food, and to make such a chicken food, various seasonings are put on a raw material such as a fried chicken. Otherwise, the seasonings are repeatedly mixed with the raw material by means of a spatula.

If a large amount of chicken is ordered, however, it is hard to manually perform such a mixing work one by one.

### DISCLOSURE

### Technical Problem

To solve the above-mentioned problems occurring in the related art, accordingly, it is an object of the present inventive concept to provide an apparatus for automatically feeding a seasoning and mixing the seasoning and a raw material.

### Technical Solution

To accomplish the above-mentioned objects, according to the present inventive concept, there is provided an apparatus for automatically mixing a seasoning and a raw material, including: a plurality of mixing containers in each of which the raw material is put; a seasoning discharger located on top of one side of each mixing container and adapted to adjust a temperature of the seasoning to spray the seasoning into the corresponding mixing container; a plurality of agitators located inside each mixing container to mix the seasoning and the raw material; and a controller for selectively controlling the operations of the seasoning discharger and the plurality of agitators.

According to the present inventive concept, the seasoning discharger may include: a nozzle-fixing rod located on top of the corresponding mixing container in the transverse direction of the mixing container; a plurality of spray nozzles spaced apart from one another in the transverse direction of the corresponding mixing container in such a way as to be mounted onto the nozzle-fixing rod; and a heating wire for surrounding the outer peripheral surface of each spray nozzle.

According to the present inventive concept, the apparatus may further include transfer parts for horizontally moving each seasoning discharger.

According to the present inventive concept, the apparatus may further include: a plurality of seasoning containers in each of which the seasoning is stored; a seasoning feed pipe located between each seasoning container and each seasoning discharger; a seasoning feed pump mounted on the seasoning feed pipe to compressedly transfer the seasoning to the corresponding seasoning discharger; an air feed pipe connected to the corresponding seasoning discharger; and an air feed pump mounted on the air feed pipe to compressedly transfer air to the corresponding seasoning discharger.

According to the present inventive concept, the apparatus may further include: an opening and closing valve mounted on the corresponding seasoning feed pipe; a water feeder for feeding washing water; a water feed pipe located between the water feeder and the opening and closing valve; and water discharge pipes connected to the underside of each mixing container.

### Effective Advantages of the Inventive Concept

According to the present inventive concept, the nozzle-type apparatus for automatically mixing a seasoning and a raw material is configured to have the plurality of mixing containers so that each seasoning discharger and the agitators located inside each mixing container operate to feed the seasoning and mix the seasoning with the raw material according to large amounts of food ordered.

Further, the nozzle-type apparatus according to the present inventive concept is configured to allow the temperature of the seasoning to be adjusted according to the optimal temperature of the seasoning used for a food.

Moreover, the nozzle-type apparatus according to the present inventive concept is configured to repeatedly move each seasoning discharger so that the seasoning is evenly sprayed into the raw material, thereby enhancing the mixing efficiency thereof.

Besides, the nozzle-type apparatus according to the present inventive concept is configured to feed air or washing water after opening hours have ended so that the seasoning dischargers and the mixing containers are washed, thereby ensuring the health thereof.

### DESCRIPTION OF DRAWINGS

FIG. 1 is a perspective view showing a nozzle-type apparatus for automatically mixing a seasoning and a raw material according to the present inventive concept.

FIGS. 2a and 2b are perspective and bottom views showing a first example of a mixing container of FIG. 1.

FIG. 3 is a front view showing a seasoning discharger of FIG. 1.

FIGS. 4a and 4b are enlarged views showing first and second examples of a spray nozzle of FIG. 3.

FIG. 5 is a perspective view showing a second example of the mixing container of FIG. 1.

FIG. 6 is a schematic sectional view showing a portion ‘A’ of FIG. 5.

FIGS. 7 and 8 are perspective and plan views showing a moving state of the seasoning discharger of the mixing container of FIG. 5.

FIG. 9 is a schematic sectional view showing a seasoning container of the nozzle-type apparatus of FIG. 1.

FIG. 10 is a block diagram showing a structure for feeding the seasoning and washing water in the nozzle-type apparatus of FIG. 1.

FIG. 11 is a schematic sectional view showing a water discharge pipe of the nozzle-type apparatus of FIG. 1.

FIG. 12 is a block diagram showing a controller of the nozzle-type apparatus of FIG. 1.

### MODE FOR INVENTIVE CONCEPT

Hereinafter, an embodiment of the present inventive concept will be described in detail with reference to the attached drawings so that it may be carried out easily by those having ordinary skill in the art.

For reference numerals, with respect to the same elements, even though they may be displayed in different drawings, such elements use same reference numerals as much as possible.

Also, in explaining the example embodiments, detailed description on known elements or functions will be omitted if it is determined that such description will interfere with understanding of the embodiments.

In the description, when it is said that one member is located “above” another member, it means that one member may be located toward a mixing container as will be discussed later with respect to a refrigerator as will be discussed later.

Further, components of a nozzle-type apparatus for automatically mixing a seasoning and a raw material according to the present inventive concept are fixed to one another by means of known fixing members such as bolts, screws, pieces, ties, clamps, and the like or known adhesive members such as glue, adhesive spray, and the like.

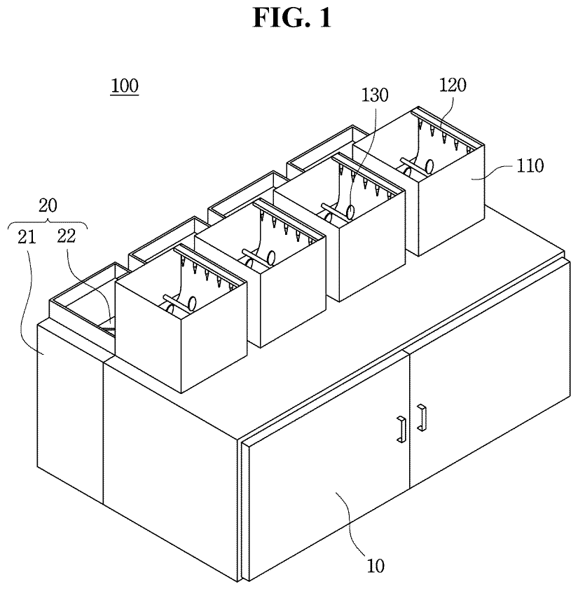

Hereinafter, an explanation of a nozzle-type apparatus for automatically mixing a seasoning and a raw material according to the present inventive concept will be given in detail with reference to FIGS. 1 to 12.

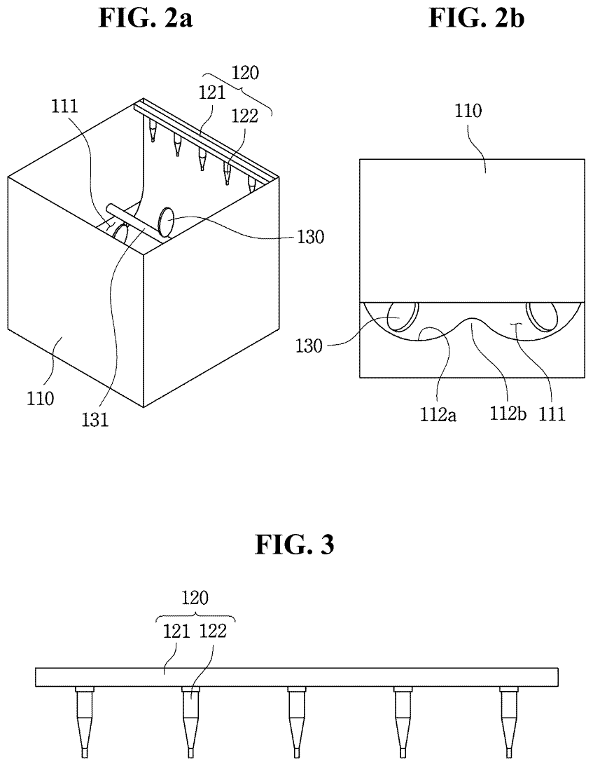

FIG. 1 is a perspective view showing a nozzle-type apparatus for automatically mixing a seasoning and a raw material according to the present inventive concept, and FIGS. 2a and 2b are perspective and bottom views showing a first example of a mixing container of FIG. 1.

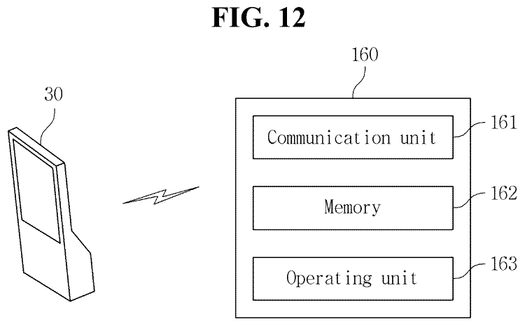

Referring to FIGS. 1 to 2b, a nozzle-type apparatus 100 for automatically mixing a seasoning and a raw material according to the present inventive concept includes a plurality of mixing containers 110, a plurality of seasoning dischargers 120, a plurality of agitators 130, a refrigerator 10, a plurality of storage containers 20, and a controller 160 (See FIG. 12).

Each mixing container 110 has the shape of a hexahedron whose interior is empty and is open on top thereof to put the raw material thereinto.

In this case, the raw material may be an object, for example, chicken, which is to be mixed with the seasoning.

Desirably, the mixing container 110 is made of a known material with given stiffness, such as steel, alloy steel, synthetic resin, and the like, but more desirably, the mixing container 110 is made of stainless steel that has the power to resist discoloring and is sanitary in consideration of its washing and mixing work performed therein.

The plurality of mixing containers 110 are located on top of the refrigerator 10 in such a way as to be spaced apart from one another in a line to perform a large number of mixing processes.

Each mixing container 110 has ridges 112 and valleys 112a formed repeatedly on the bottom surface thereof along a longitudinal direction thereof and a discharge hole 111 formed on one side surface thereof in such a way as to discharge the raw material mixed with the seasoning therethrough.

Each seasoning discharger 120 is located on top of one side of the mixing container 110 and adjusts a temperature of the seasoning to spray the seasoning whose temperature is adjusted into the mixing container 110.

Each agitator 130 represents, for example, a propeller impeller, which is located inside the mixing container 110 and rotates by means of an electric motor to mix the seasoning and the raw material.

The agitator 130 has a rotary shaft 131 adapted to pass through both side surfaces of the mixing container 110 in a transverse direction of the mixing container 110, and the electric motor is mounted on the end portion of the rotary shaft 131 on the outer surface of the mixing container 110.

The plurality of agitators 130 are spaced apart from one another above the valleys 112a in the corresponding mixing container 110.

That is, if the agitators 130 rotate forward, they push the raw material toward the inside of the mixing container 110 to allow the raw material and the seasoning to be mixed with each other, and contrarily, if the agitators 130 rotate backward, they push the raw material toward the outside of the mixing container 110 to allow the raw material whose mixing with the seasoning is completed to be discharged through the discharge hole 111.

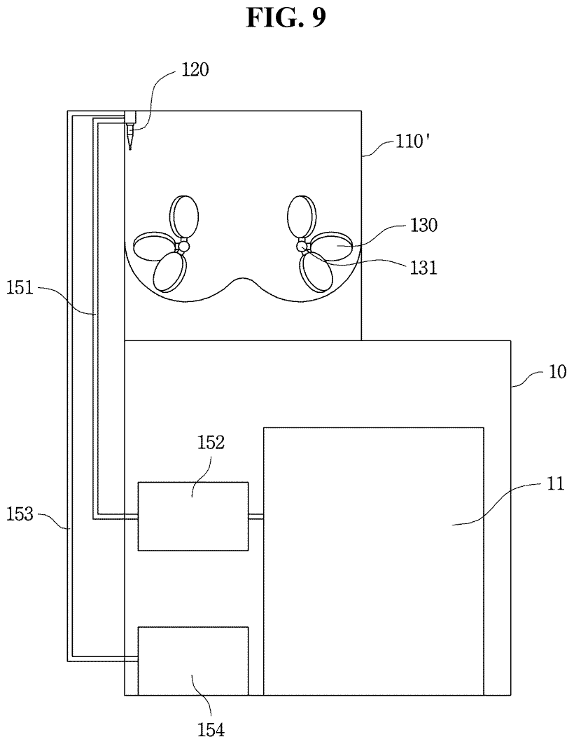

The refrigerator 10 has seasoning containers 11 (See FIG. 9) in each of which the seasoning is stored in the interior thereof so that the seasoning is kept at a low temperature.

Each storage container 20 has the shape of a polyhedron whose inside is empty and is made of the same material as the mixing container 110.

The storage container 20 is open on top thereof to form a storage space portion 21 in which the raw material discharged through the discharge hole 111 is stored, and a tilt plate 22 is located between the storage container 20 and the mixing container 110 in such a way as to allow the raw material to be inserted into the storage container 20 therealong.

The controller 160 selectively controls the operations of the seasoning dischargers 120, the agitators 130, and other components of the nozzle-type apparatus 100 according to the present inventive concept.

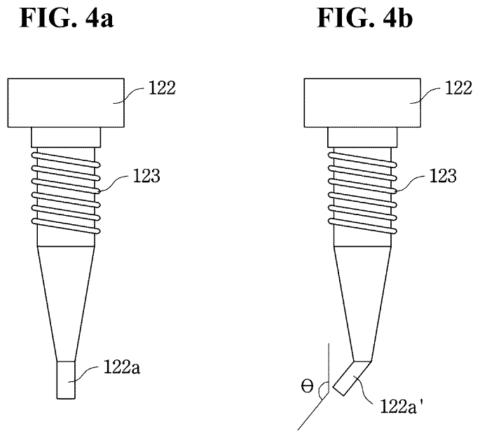

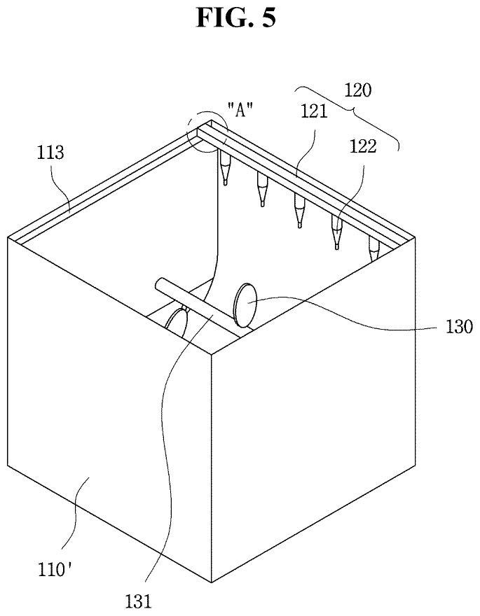

FIG. 3 is a front view showing the seasoning discharger of FIG. 1, and FIGS. 4a and 4b are enlarged views showing first and second examples of a spray nozzle of FIG. 3.

Referring to FIGS. 3 to 4b, the seasoning discharger 120 includes a nozzle-fixing rod 121, a plurality of spray nozzles 122, and heating wires 123.

The nozzle-fixing rod 121 is located on top of each mixing container 110 in the transverse direction of the mixing container 110 and allows both ends thereof to be fixed to the inner surfaces of the mixing container 110.

The spray nozzles 122 are made of stainless steel and spaced apart from one another in the transverse direction of the corresponding mixing container 110 in such a way as to allow top ends thereof to be fixed to the nozzle-fixing rod 121 to cause undersides thereof to be located toward the bottom of the mixing container 110.

In this case, the nozzle-fixing rod 121 has a flow path formed along the transverse direction of the mixing container 110 in such a way as to communicate with the spray nozzles 122.

As shown in FIG. 4a, each spray nozzle 122 has a linear bottom end 122a, and as shown in FIG. 4b, each spray nozzle 122 has a tilt bottom end 122a′ by a given angle. As a result, the spray angle for the seasoning may be varied.

That is, the seasoning is sprayed at various angles from the plurality of spray nozzles 122, so that the mixing process between the raw material and the seasoning can be performed more smoothly.

Each heating wire 123 fixedly surrounds the outer peripheral surface of the corresponding spray nozzle 122 and is connected to an external power source and heated by the application of an electric current to allow the corresponding spray nozzle 122 to be heated.

If the seasoning has a high degree of viscosity or is hardened due to the storage at a low temperature, it is hard to flow the seasoning smoothly, and further, the spray nozzles 122 may be clogged with the seasoning.

Therefore, the controller 160 applies the electric current to the heating wires 123 according to predetermined temperatures based on the types of seasonings and thus allows the spray nozzles 122 to be heated to the predetermined temperatures.

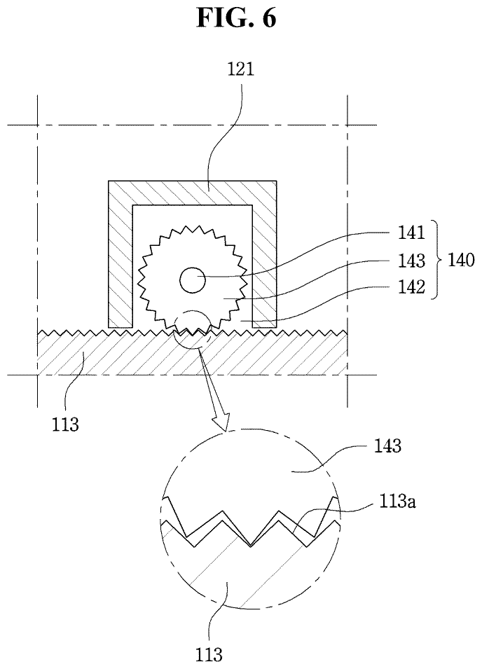

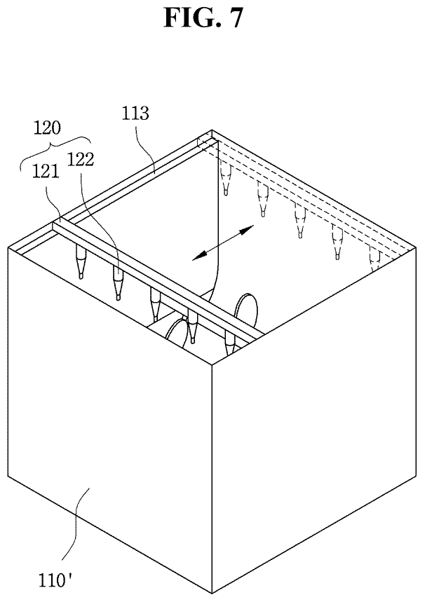

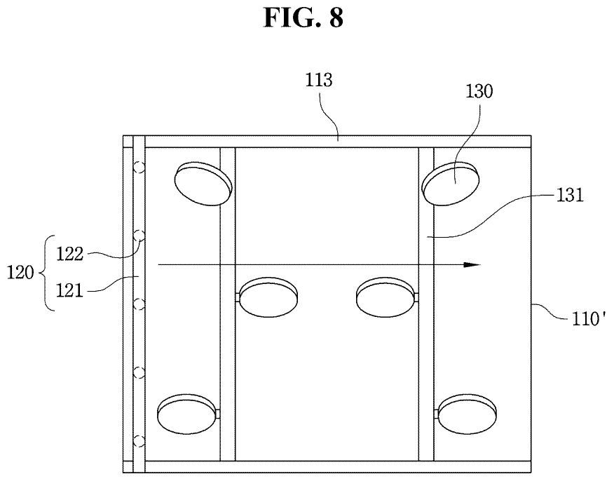

FIG. 5 is a perspective view showing a second example of the mixing container of FIG. 1, FIG. 6 is a schematic sectional view showing a portion ‘A’ of FIG. 5, and FIGS. 7 and 8 are perspective and plan views showing a moving state of the seasoning discharger of the mixing container of FIG. 5.

Referring to FIGS. 5 to 8, the nozzle-type apparatus 100 according to the present inventive concept further includes a pair of transfer parts 140 located on each seasoning discharger 120.

The pair of transfer parts 140 are located on both sides of the seasoning discharger 120 to horizontally move the seasoning discharger 120, and each transfer part 140 includes a rotational motor 142 and a gear 143.

The rotational motor 142 is buried into the end portion of the nozzle-fixing rod 121, and the gear 143 is fixedly fitted to a motor shaft 141 of the rotational motor 142.

Each mixing container 110′ has locking projections 113 formed on the inner surfaces of the upper portion thereof along the longitudinal direction thereof in such a way as to allow the gears 143 of the transfer parts 140 to be seated thereonto.

In this case, each locking projection 113 has a plurality of teeth 113a along the longitudinal direction of the mixing container 110′ in such a way as to be engaged with the corresponding gear 143.

That is, if it is desired to spray the seasoning, the controller 160 operates the transfer parts 140, that is, the rotational motors 142 to repeatedly move the corresponding seasoning discharger 120 by the predetermined number of times, so that the seasoning is evenly sprayed into the raw material.

FIG. 9 is a schematic sectional view showing the seasoning container of the nozzle-type apparatus of FIG. 1.

Referring to FIG. 9, the nozzle-type apparatus 100 according to the present inventive concept further includes the seasoning containers 11, seasoning feed pipes 151, seasoning feed pumps 152, air feed pipes 153, and air feed pumps 154.

Each seasoning container 11 is a container in which the seasoning is stored, has various shapes such as a polyhedron or cylinder, and is made of a known material having given stiffness, such as glass, synthetic resin, steel, alloy steel, and the like.

Each seasoning feed pipe 151 and each air feed pipe 153 are made of, for example, steel or synthetic resin, and each seasoning feed pipe 151 is located between the corresponding seasoning container 11 and the seasoning discharger 120 corresponding to the seasoning container 11 in such a way as to communicate with them.

Each seasoning feed pump 152 is mounted on the corresponding seasoning feed pipe 151 to compressedly transfer the seasoning to the corresponding seasoning discharger 120.

Each air feed pipe 153 is connected to the corresponding seasoning discharger 120 and thus communicates with the corresponding seasoning discharger 120, and the air feed pump 154 is mounted on the corresponding air feed pipe 153 to compressedly transfer air to the corresponding seasoning discharger 120.

In this case, the seasoning feed pipe 151 and the air feed pipe 153 communicate with the nozzle-fixing rod 121 so that the seasoning and air are sprayed through the flow path of the nozzle-fixing rod 121 and the spray nozzles 122.

Otherwise, the seasoning feed pipe 151 and the air feed pipe 153 directly communicate with the spray nozzles 122 so that the seasoning and air are sprayed from the spray nozzles 122.

That is, after the seasoning has been sprayed, or in a state where the seasoning discharger 120 is returned to its original position, the controller 160 operates the air feed pump 154 to allow the air to be sprayed from the seasoning discharger 120 for a predetermined period of time.

Therefore, the seasoning remaining in the interior of the nozzle-fixing rod 121 or each spray nozzle 122 is completely discharged to prevent the nozzle-fixing rod 121 or each spray nozzle 122 from being clogged or contaminated therewith.

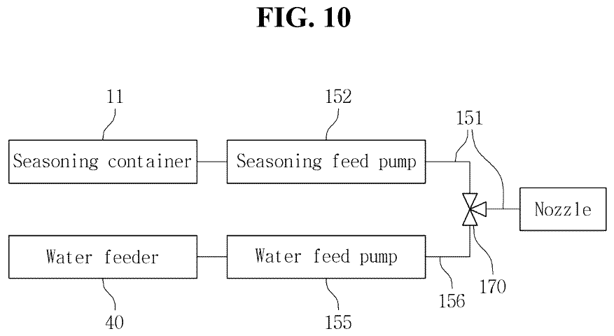

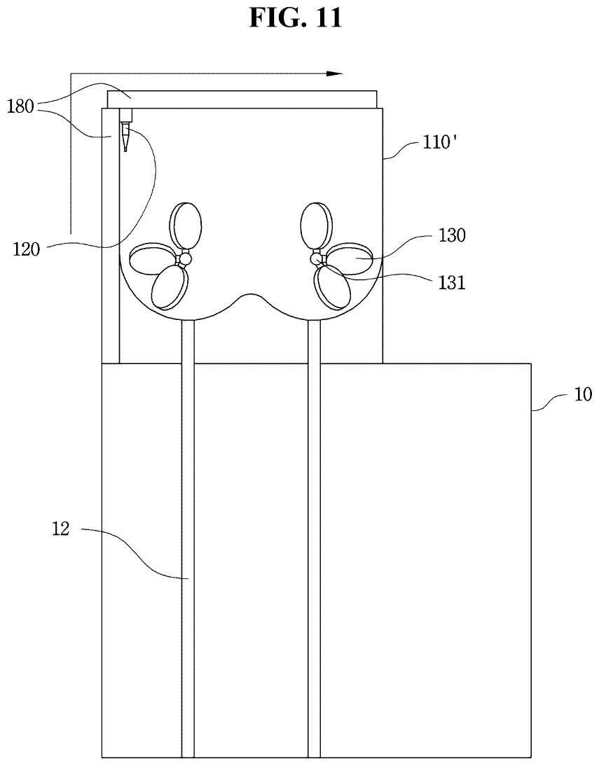

FIG. 10 is a block diagram showing a structure for feeding the seasoning and washing water in the nozzle-type apparatus of FIG. 1, and FIG. 11 is a schematic sectional view showing a water discharge pipe of the nozzle-type apparatus of FIG. 1.

Referring to FIGS. 10 and 11, the nozzle-type apparatus 100 according to the present inventive concept further includes opening and closing valves 170, water feeders 40, water feed pipes 156, water discharge pipes 12, and covers 180.

Each opening and closing valve 170 is a three-way valve, for example, a solenoid valve that is mounted on the corresponding seasoning feed pipe 151.

The water feed pipes 156 and the water discharge pipes 12 are made of, for example, steel or synthetic resin. Each water feed pipe 156 is located between the corresponding water feeder 40 and the corresponding opening and closing valve 170 in such a way as to communicate with them, and the water feeder 40 is, for example, a water tap for feeding warm or cold washing water.

The water discharge pipes 12 are connected to the underside of each mixing container 110′ in such a way as to communicate with the mixing container 110′ and the outside.

In detail, one end of each water discharge pipe 12 passes through the bottom of the mixing container 110′, that is, the valley 112a and thus communicates with the inside of the mixing container 110′, and the other end thereof passes through the refrigerator 10 in such a way as to be located on the outside of the refrigerator 10.

In this case, the other end of each water discharge pipe 12 may be located directly on the outside, without passing through the refrigerator 10.

The covers 180 have the shapes of plates, are made of known materials having given stiffness, such as steel or synthetic resin, and are located on top and one side of the mixing container 110′ to close top of the mixing container 110′ and the discharge hole 111.

That is, if it is desired to wash the mixing container 110′ after opening hours have ended, the opening and closing valve 170 operates under the control of the controller 160 so that the mixing container 110′ and the water feeder 40 communicate with each other to allow washing water to be sprayed from the seasoning discharger 120.

Further, the transfer parts 140 operate under the control of the controller 160 so that the seasoning discharger 120 repeatedly moves by the predetermined number of times.

Therefore, the seasoning remaining in the interior of the nozzle-fixing rod 121 or each spray nozzle 122 is discharged and removed, and further, the nozzle-fixing rod 121 or each spray nozzle 122 is washed, so that the seasoning existing in the agitators 130 and the mixing container 110′ can be completely removed by means of the washing water sprayed into the mixing container 110′.

The washing water sprayed into the mixing container 110′ is discharged to the outside through the water discharge pipes 12, without being scattered to the outside by means of the covers 180, thereby ensuring the health of the nozzle-type apparatus 100 according to the present inventive concept.

FIG. 12 is a block diagram showing the controller of the nozzle-type apparatus of FIG. 1.

Referring to FIG. 12, the controller 160 includes a communication unit 161, a memory 162, and an operating unit 163.

The communication unit 161 is connected wirelessly (e.g., Wi-Fi, Bluetooth, etc.) or wiredly with an external ordering device 30.

The ordering device 30 is, for example, a kiosk through which a food is selected to produce ordering data.

The memory 162 presets and stores data related to seasonings, such as amounts of seasonings by food and optimal temperatures by seasoning, and data related to the operations of the components of the nozzle-type apparatus 100 according to the present inventive concept, such as the number of times moving of the seasoning discharger 120, the rotational speeds of the agitators 130, and the number of times for the spray of the washing water.

The operating unit 163 selectively operates the components of the nozzle-type apparatus 100 according to the present inventive concept, based on the ordering data or the data stored in the memory 162.

As described above, the nozzle-type apparatus according to the present inventive concept is configured to have the plurality of mixing containers so that each seasoning discharger and the agitators located inside each mixing container operate to feed the seasoning and mix the seasoning with the raw material according to large amounts of food ordered.

Further, the nozzle-type apparatus according to the present inventive concept is configured to allow the temperature of the seasoning to be adjusted according to the optimal temperature of the seasoning used for a food.

Moreover, the nozzle-type apparatus according to the present inventive concept is configured to repeatedly move each seasoning discharger so that the seasoning is evenly sprayed into the raw material, thereby enhancing the mixing efficiency thereof.

Besides, the nozzle-type apparatus according to the present inventive concept is configured to feed air or washing water, after opening hours have ended, so that the seasoning dischargers and the mixing containers are washed, thereby ensuring the health thereof.

As mentioned above, the preferred embodiment of the present inventive concept has been disclosed in the specification and drawings. In the description of the present inventive concept, special terms are used not to limit the present inventive concept and the scope of the present inventive concept as defined in claims, but just to explain the present inventive concept. Therefore, persons skilled in the relevant art can appreciate that many modifications and variations are possible in light of the above teachings. It is therefore intended that the scope of the inventive concept be limited not by this detailed description, but rather by the claims appended hereto.

1. A nozzle-type apparatus for automatically mixing a seasoning and a raw material, comprising;
a plurality of mixing containers in each of which the raw material is put;
a seasoning discharger located on top of one side of each mixing container and adapted to adjust a temperature of the seasoning to spray the seasoning into the corresponding mixing container;
a plurality of agitators located inside each mixing container to mix the seasoning and the raw material; and
a controller for selectively controlling the operations of the seasoning discharger and the plurality of agitators.

2. The apparatus according to claim 1, wherein the seasoning discharger comprises:
a nozzle-fixing rod located on top of the corresponding mixing container in the transverse direction of the mixing container;
a plurality of spray nozzles spaced apart from one another in the transverse direction of the corresponding mixing container in such a way as to be mounted onto the nozzle-fixing rod; and
a heating wire for surrounding the outer peripheral surface of each spray nozzle.

3. The apparatus according to claim 1, further comprising transfer parts for horizontally moving each seasoning discharger.

4. The apparatus according to claim 1, further comprising:
a plurality of seasoning containers in each of which the seasoning is stored;
a seasoning feed pipe located between each seasoning container and each seasoning discharger;
a seasoning feed pump mounted on the seasoning feed pipe to compressedly transfer the seasoning to the corresponding seasoning discharger;
an air feed pipe connected to the corresponding seasoning discharger; and
an air feed pump mounted on the air feed pipe to compressedly transfer air to the corresponding seasoning discharger.

5. The apparatus according to claim 4, further comprising:
an opening and closing valve mounted on the corresponding seasoning feed pipe;
a water feeder for feeding washing water;
a water feed pipe located between the water feeder and the opening and closing valve; and
water discharge pipes connected to the underside of each mixing container.
